(19) United States
(12) Patent Application Publication
(10) Pub. No.: US 2023/0281639 A1
(43) Pub. Date: Sep. 7, 2023

(54) A METHOD FOR CONFIRMING THE CREDENTIALS OF A USER

(71) Applicant: IBUILDPRO HOLDINGS LIMITED, London (GB)

(72) Inventors: Allar AHTMANN, London (GB); Keano CHANG, London (GB)

(73) Assignee: IBUILDPRO HOLDINGS LIMITED, London (GB)

(21) Appl. No.: 18/008,122

(22) PCT Filed: May 27, 2021
(86) PCT No.: PCT/GB2021/051308

§ 371 Date: Dec. 2, 2022

(30) Foreign Application Priority Data
Jun. 4, 2020 (GB) 2008410.9

(51) Int. Cl. G06Q 30/018

(52) U.S. Cl. CPC G06Q 30/018

(57) ABSTRACT

The present invention relates to a computer implemented method for confirming the credentials of a user comprising the method steps of: allowing the user to create a profile containing verifiable data; recording the verifiable data to a central resource; cross checking an item of verifiable data with a reference source; recording data associated with the result of the cross check to the central resource; and recording data associated with at least one method step to the central resource.

### FIELD OF THE INVENTION

The present invention relates to a computer implemented method for confirming the credentials of a user. The present invention further relates to a data processing apparatus for carrying out the computer implemented method. The present invention also relates to a computer program for causing a computer to carry out the computer implemented method. The present invention further relates to a computer-readable medium for causing a computer to carry out the computer implemented method.

### BACKGROUND TO THE INVENTION

Establishing trust in a tradesperson or professional is important, not just for potential clients and customers but for employers, trainers and others working in the industry. It is desirable to know that someone is a reputable tradesperson or professional who has adequate accreditations and or qualifications, up-to-date training and provides a good quality of work. This is of particular importance when safety, cost and access to a person's property are considered.

Often, word-of-mouth as well as proof of accreditation and or qualification and accreditation are used to establish trust in a tradesperson or professional. If a good reputation has been built in someone's colleagues, employer or company, trust can be gained by association. Additionally, a number of different information sources are often used to verify quality of work, including online reviews on company websites, social media and, for tradespeople, other dedicated trades platforms. It can be arduous and time consuming to collate information on tradespeople an/or professionals and it can be difficult to establish trust in these sources of information. Additionally, it can be challenging for those new to a trade or a profession, and without others to confirm their reputability, to be accepted into trainee, apprentice and employment positions.

There is also a need for greater transparency and credential checking of tradespersons and professionals, as such mediums are open to abuse, for example through spreading of misinformation, fraudulent proof of accreditation and or qualification and dishonest claims and reviews. A reliable and accurate means to verify the credentials of a tradesperson and professionals is required, without opportunity for such abuse. Similar considerations are also important when considering service providers in general.

Embodiments and aspects of the present invention seek to address at least the above problems of the prior art.

### SUMMARY OF THE INVENTION

According to a first aspect of the present invention there is provided a computer implemented method for confirming the credentials of a user comprising the method steps of: allowing the user to create a profile containing verifiable data; recording the verifiable data to a central resource; cross checking an item of verifiable data with a reference source; recording data associated with the result of the cross check to the central resource; and recording data associated with at least one method step to the central resource.

In this way there is advantageously provided a method wherein a reliable and accurate collation of verified user credentials is built to a central resource. Such a resource is of great advantage when dealing with members of the construction and building trades. Such a resource is also advantageous when considering service providers and professionals in general, whether these service providers are companies or individuals.

Preferably, the method comprises cross checking an item of verifiable data against a plurality of reference sources. More preferably, the method comprises cross checking a plurality of items of verifiable data against a plurality of reference sources. Using a plurality of reference sources may increase the accuracy of any cross check.

Preferably, the method comprises the further review step of: comparing data associated with two or more method steps recorded to the central resource; and issuing an alert if the comparison produces a result outside of a desired range. Preferably, the review step comprises determining the desired range from data stored on the central resource. Preferably, the data stored on the central resource comprises prior user data associated with a prior user.

Preferably, the review step further comprises recording data associated with the presence or absence of an alert to the central resource. Preferably, the data comprises the time the method steps were completed, comparing the data associated with the completion of two or more method steps recorded to the central resource comprises determining the elapsed time period between the completion of the two or more method steps; and issuing an alert if the comparison produces a result outside of a desired range comprises issuing a time alert if the elapsed time period is outside of a desired range. For example, if the elapsed time period is unexpectedly short it may be because multiple parties are working together to input false information. The same may also be true when the elapsed time period is unduly long.

Preferably, the data comprises location information, comparing the data associated with the completion of two or more method steps recorded to the central resource comprises determining the proximity between the locations where completion of the two or more method steps occurred; and issuing an alert if the comparison produces a result outside of a desired range comprises issuing a proximity alert if the proximity is outside of a desired distance range. For example, if two method steps are competed in close proximity to one another, this may indicate that the information provided during the completion of these method steps is inaccurate or false.

Preferably, the method comprises the further steps of: reviewing the data associated with at least one method step recorded to the central resource, wherein the data comprises location information; comparing the location information to an item of verifiable information contained within the profile; and issuing a location alert if there is a discrepancy between the location information and the item of verifiable information. For example, if the profile includes information assigning a location to a user and the location information diverges from the verifiable information contained within the profile, this may indicate an increased likelihood of fraudulent activity.

Preferably, the or the plurality of reference sources comprises a third-party database. Preferably, the or the plurality of reference sources comprises the central resource. Preferably, the or the plurality of reference sources comprises information provided by a customer or quality controller. A quality controller may be a specific party authorised to asses the quality of any given work or service. Alternatively, quality controller may be interpreted as any third party that verifies the quality of work or service, preferably based on selected criteria. Where the or the plurality of reference sources comprises the central resource this allows the collation of a large amount of data in a central location, increasing the ease and accuracy of the verification procedures and checks.

Preferably, the or the plurality of reference sources comprises information provided by a second user. More preferably, the method further comprises recording the association between the user and the second user in the central resource. Preferably, the method further comprises the step of defining a predetermined relationship status to the association between the user and the second user and recording this relationship in the central resource.

Preferably, the method simultaneously confirms the credentials of multiple users. Preferably, the method comprises the further steps of analysing the data recorded in the central resource, and providing each user with a user score. In this way, there is provided a single indicator to summarise the user data. More preferably, the method comprises the further step of recording each user's user score in the central resource. Still more preferably, the method comprises the further step of continually or periodically reviewing the data recorded in the central resource, and updating each user's user score. In this way, continuous review of a user's credentials is undertaken to ensure accurate data is maintained over a period of time. Preferably, the step of continually or periodically reviewing the data recorded in the central resource, and updating each user's user score includes reviewing the user score of all associated users. This ensures that up-to-date verification and scoring of each user is maintained, and that the score of each use reflects the score of their associates.

Preferably, the method comprises the further step of ranking each user by their user score. In this way, the user may be assessed based on their standings within the user base and/or against a set target or criteria.

According to a second aspect of the present invention there is provided a data processing apparatus comprising means for carrying out the method according to the first aspect of the invention.

According to a third aspect of the present invention there is provided a computer program comprising instructions which, when the program is executed by a computer, cause the computer to carry out the method according to the first aspect of the present invention.

According to a fourth aspect of the present invention there is provided a computer-readable medium comprising instructions which, when executed by a computer, cause the computer to carry out the method of the first aspect of the present invention.

### DETAILED DESCRIPTION

Embodiments of the present invention will now be described by way of example and with reference to the accompanying drawings, in which:

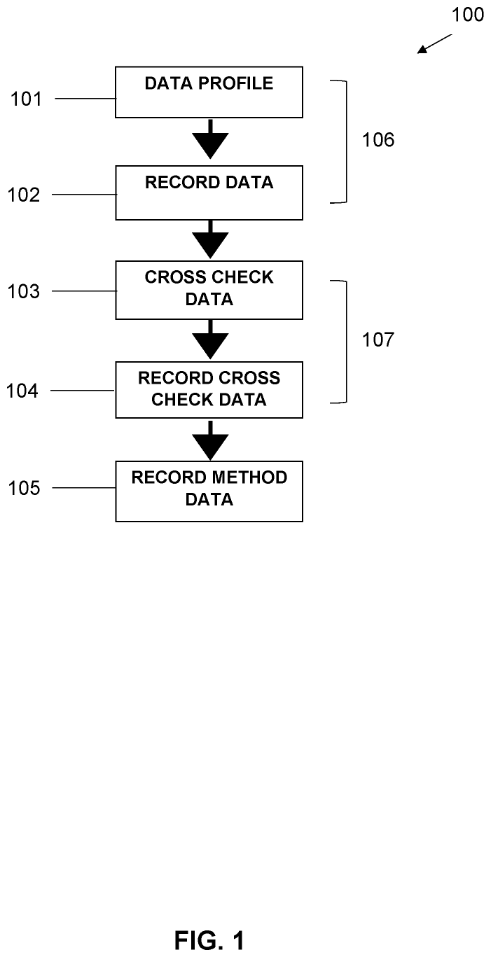

FIG. 1 is a schematic view of a computer implemented method according to the first aspect of the present invention; and

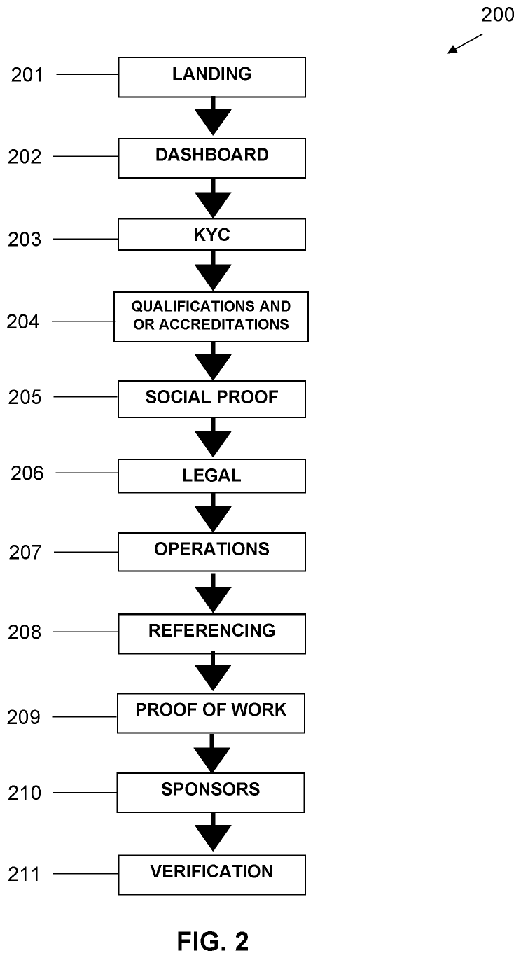

FIG. 2 is a schematic view of a second embodiment of the computer implemented method of FIG. 1, according to the first aspect of the present invention.

Herein, the method is described in relation to a tradesperson, but it is envisaged that the method and related technology can also be applied to any service provider or profession on an individual or company wide basis.

Referring firstly to FIG. 1, there is shown schematic view of a computer implemented method 100, according to the first aspect of the invention. The method 100 allows a user to provide data for verification such that the user's credentials are verified and trust in the user may be established by others.

The first step of the method 100 is a DATA PROFILE step 101. Herein, the user is allowed to create a profile containing verifiable data. For example, this data can be in the form of; personal data, such a name, age and contact details; data on education, such as qualifications and accreditations; historical data, such as data on past performance and previous employment; and data concerning others, such as data concerning a previous employer. The data contained in the user profile may be provided in the form of documentation, such as ID or certificates, hyperlinks to websites and images. In this example, the verifiable data is the user's name and that the user is an approved member of a professional register, namely an approved gas engineer on the ‘UK Gas Safe Register’.

The next step of the method 100 is a RECORD DATA step 102, wherein the verifiable data is recorded to a central resource, such as a central database or central ledger. The user's name and data regarding the ‘Gas Safe Register’ membership of the user are recorded onto the central resource. The DATA PROFILE step 101 and RECORD DATA step 102 form the PROVIDE phase 106 of the method 100.

Following this, a CROSS CHECK DATA step 103 comprises cross checking an item of verifiable data with a reference source. In this example, the reference source is an official database of approved members of the ‘Gas Safe Register’ as provided by the Registration Body. The CROSS CHECK DATA step 103 determines whether the user's name is found on the Register and cross checks this with the data provided by the user in the DATA PROFILE step 101. The CROSS CHECK DATA step 103 provides a result, either that the provided user credentials are correct, or that the provided user credentials are incorrect.

The data associated with the result of the CROSS CHECK DATA step 103 is recorded to the central resource in a RECORD CROSS CHECK DATA step 104. In this way, the central resource comprises both the user-provided data and the cross checked data. The CROSS CHECK DATA step 103 and the RECORD CROSS CHECK DATA step 104 form the CROSS CHECK phase 107 of the method 100.

Next, data associated with the DATA PROFILE step 101 is recorded to the central resource, including the time and IP data, in a RECORD METHOD DATA step 105. The IP data can be used to identify the user's device type, host name, proxy, IP address as well as IP location, providing information regarding the location of the user.

A benefit of confirming a user's credentials is that a profile of factual, accurate user information can be built, improving user reputation and trustworthiness of the user-provided data profile. Additionally, the user data is collated, verified and recorded in a central resource so all data is stored collectively.

With reference to FIG. 2, there is provided a schematic view of a further embodiment of the computer implemented method according to the first aspect of the present invention. The method 200 comprises the stages undertaken such that a user's credentials are verified. The method 200 stages are carried out on a computer via user access to a software and or website platform. It is envisaged that the method 200 stages may be undertaken in an alternative order to that presented in the embodiment.

The method 200 comprises a number of PROVIDE phases 106, CROSS CHECK phases 107 and RECORD METHOD DATA steps 105 in accordance with the embodiment of FIG. 1. Data regarding each stage of the method 200 is recorded to the central resource in the RECORD METHOD DATA steps 105.

The first stage of the method 200 is a LANDING stage 201 comprising a DATA PROFILE step 101 as outlined in the embodiment of FIG. 1. The user inputs a plurality of data to a landing page of the software and or website platform, such as their category of trade, location, email address and password. This allows a user profile to be created and accessed by the user. The data from the LANDING stage 201, such as the time and IP data, is recorded to the central database in a RECORD METHOD DATA step 105, and similar data is recorded in similar steps in the proceeding stages of the method 200. A QR tag is created for each user such that a unique verification ID is created.

There follows a DASHBOARD stage 202 wherein the data inputted in the LANDING stage 201 is recorded to a central resource. In this way, a reward or affiliate wallet of the user's data is created in the central resource. The DASHBOARD stage 202 further comprises the verification of user contact details, such as sending an email containing a hyperlink to the user's email address through which the user may verify this email address.

Next, a KNOW YOUR CUSTOMER (KYC) stage 203 is initiated. The KYC stage 203 comprises a PROVIDE phase 106 as outlined in the first embodiment. Herein, the user is allowed to input verifiable data, such as their name, age, address, location of trade operation and employer. Further, the user is requested to provide proof of this data in the form of official documentation, such as a copy of an ID, passport, driving license or employment contract. This data is recorded to the central resource such that a general wallet of the user's data is created in the central resource. The KYC stage 203 also comprises a RECORD METHOD DATA step 105, wherein user IP data is recorded to the central resource.

The KYC stage 203 further comprises a CROSS CHECK phase 107, wherein the verifiable data provided in the PROVIDE phase 106 is cross checked against a reference source, and the result of the cross check is recorded on the central database. For example, the user's driving license details are cross checked against a third-party database, namely an official Government database of qualified drivers. Each item of verifiable data is cross checked against a plurality of reference sources, where available, to improve accuracy and reliability of the verification method 200.

If the verifiable data fails to correspond with the reference source, an alert is issued. The presence or absence of alert data is recorded onto the central resource and is used to verify the user verifiable data and confirm the user credentials, namely no alert indicates the user credentials are correct or verified.

The CROSS CHECK phase 107 further comprises comparing data recorded to the central resource in the DASHBOARD stage 202 with data recorded to the central resource in the KYC stage 203. The data provided on the user's location of trade operation in the KYC stage 203 is compared with the location information provided in the LANDING stage 201. The data is further compared to the IP data recorded in the RECORD METHOD DATA step 105 of the KYC stage 203. The distance between the IP location of the user, the user-inputted location and the user-inputted location of trade is compared. The comparison is reviewed to determine whether the locations are within a desired distance of one another, in order to verify the user-provided verifiable data. The desired range is determined from data stored on the central resource and an alert is issued if the comparison produces a distance outside of the desired range.

For example, if the user states that their location is ‘London’ and their location of trade operation is ‘London’, but the IP data shows the user is located in ‘Paris’, an alert is issued. This is because the distance between the users IP location and their stated location is outside the desired range. Additionally, if a user states that their location is ‘Edinburgh’ and their location of trade is ‘London’, an alert is issued as the distance between the location of the user and their location of trade is outside a range of feasible commute distance.

There follows a QUALIFICATIONS AND OR ACCREDITATIONS stage 204 comprising another PROVIDE phase 106. Herein, the user provides data regarding qualifications, accreditations, training and any professional awards, schemes and memberships, with this verifiable data being recorded to the central resource.

The QUALIFICATIONS AND OR ACCREDITATIONS stage 204 comprises a CROSS CHECK phase 107 wherein the data is cross checked against the corresponding official records and scheme providers. Additionally, the QUALIFICATIONS AND OR ACCREDITATIONS stage 204 comprises a second PROVIDE phase 106, wherein the user is asked to provide a copy of certificates and proof of attendance corresponding to the data given in the first PROVIDE phase 106.

Next, a SOCIAL PROOF stage 205 is initiated, wherein the user provides verifiable data regarding social proof of credentials. In this way, the user may provide reviews from public review websites, reviews or profile data from dedicated trades directories as well as social media reviews or client media of work completed. It is envisioned that this stage may include the provision of any publically accessible data. Additionally, a customer or quality controller can provide information for this stage. Again, following a PROVIDE phase 106, the CROSS CHECK phase 107 cross checks the social proof with reference sources, such as customer or quality controller information, to verify that the data provided is correct.

Additionally, the verifiable social proof data is cross checked with the verifiable data provided at previous stages of the method 200 and the data contained within the user profile. For example, if a customer review regarding work carried out in London is provided in the SOCIAL PROOF stage 205 and the location of trade is verified to be Edinburgh on the user profile, a location alert is issued because there is a discrepancy between the location of the social proof data and the verified location where the user operates.

The location of social proof is also cross checked with prior data recorded on the central resource. For example, if prior verifiable data recorded on the central resource provided previously by the user indicates that a prior location of trade is London, then an alert is not issued when the location of social proof data is also London, despite the user's current verified location of trade being Edinburgh. In this way, the reference source comprises the central resource.

A LEGAL stage 206 follows wherein legal documentation, such as insurance data and criminal history checks, are provided by the user in a PROVIDE phase 106 and then cross checked in a CROSS CHECK phase 107. Similarly, an OPERATIONS stage 207 wherein records of operation are provided by the user and cross checked, with the data being recorded to the central resource.

There follows a REFERENCING stage 208 wherein the user provides data regarding referees, such as customers, employers, vendors or co-workers, in a PROVIDE phase 106. The REFERENCING stage 208 comprises contacting each referee and requesting a reference, such as emailing each referee a form to complete and return. For example, if the referee is a client they may be asked: “Have you previously used services from [USER]?”, “Recalling your experience, what was it like? (1 Terrible-5 Excellent)”, “When was the job carried out?”, “Where was the job carried out?” and “What job/jobs were carried out?”. The reference form is hosted on the software and or website platform and is linked to the user such that the data provided by the user and the data provided by the referee are linked in the central resource. User action is not required regarding the reference form after the PROVIDE phase 106 of the REFERENCING stage 208, such that the referee may provide a truthful reference without risk of prejudice or pressure from the user. There follows a PROOF OF WORK stage 209, wherein the user provides evidence and proof of work, as well as their own reference from the referee.

The user-provided reference in the PROOF OF WORK stage 209 is cross checked with the reference completed by the referee in the REFERENCING stage 208. In this way, a review step wherein data associated with REFERENCING stage 208 and the PROOF OF WORK stage 209 is recorded to the central resource, is undertaken. If the result of the cross check is that the user-provided reference of the PROOF OF WORK stage 209 does not match the reference provided by the referee in the REFERENCING stage 208, an alert is issued.

Additionally, the RECORD METHOD DATA steps 105 of the REFERENCING stage 208 and the PROOF OF WORK stage 209 record the device type and or IP and time data at completion of each stage. During the CROSS CHECK phase 107 of the PROOF OF WORK stage 209, the data provided in the RECORD METHOD DATA steps 105 of the REFERENCING stage 208 and the PROOF OF WORK stage 209 is used to assist in verifying the verifiable data.

The IP data comprises location information. The location information of the referee completing the reference form in the REFERENCING stage 208 is compared with the location information of the user in the PROOF OF WORK stage 209. The locations are recorded on the central resource and the proximity between the location where completion of the reference form in the REFERENCING stage 208 occurred and the location where completion of the PROOF OF WORK stage 209 is determined. If the result of the comparison shows the proximity of the locations are outside of a desired range, namely the locations are too close together or are the same, then a proximity alert is issued. This assists in preventing the user, or a member of the users household, from fraudulently acting as the referee and providing the referee data themselves.

Next, a SPONSORS stage 210 may be initiated if appropriate for the user. It may be appropriate for the SPONSOR stage to be initiated if the user is inexperienced, unqualified or at an early career stage. The user is prompted to provide data regarding a sponsor in a PROVIDE phase 106, such as sponsor name, sponsor email, trade category, sponsor accreditations and sponsor competitor reviews. Herein, the SPONSORS stage 210 further comprises the step of providing sponsors social proof in a similar manner to the steps undertaken in the SOCIAL PROOF stage 205 for providing the users social proof.

In a similar manner to the reference form of the REFERENCING stage 208, a sponsor form is emailed to the sponsor for competition. Such a form requests the sponsor to confirm that the information provided by the user in the PROVIDE phase 106 of the SPONSORS stage 210 is correct. Additionally, the sponsor is requested to provide business information and data regarding themselves, similar to that which is provided by the user in the KYC stage 203.

If the sponsor is a second user, data may be taken from the central resource regarding the second user to cross check with the information provided by both the user and the second user. In this way, the reference source comprises information provided by the second user.

The method 200 comprises recording the association between the user and the second user, such that data regarding the user and second user is linked in the central resource. This association is assigned a predetermined relationship, in this case, the user is the trainee and the second user is the trainer. The trainee/trainer relationship between the two users is recorded on the central resource.

There follows a VERIFICATION stage 211 wherein it is determined whether the verifiable data is verified, and the credentials on the user profile are confirmed, by providing the user with a user score which is recorded to the central resource. In this way, the central resource comprises the user score of all users.

The user score is determined by the quantity of alerts, with each alert being weighted based on its importance in determining that the user is reputable. The lower the number of alerts and the weighting of the received alerts, the higher the user score and the greater the level of verification that has been achieved. The user score provides a quantified, simple indicator of the level of trust that can be placed in the information of the user and their profile and ultimately the user themselves.

If a user fails to meet a minimum user score then their profile may be removed from the platform and they may not be allowed to seek verification of their credentials before a specified period of time has elapsed.

Further, the user score is used to rank each user such that each user falls within a predetermined band. This motivates users to improve their user score such that they can progress to a higher band. In this embodiment, the bands include ‘Junior Talent: looking to enrol/an existing apprentice’, ‘Rising Talent: Newly graduated/Little or no industry experience’, ‘Advanced Talent: Moderate industry experience (5+ years)’, ‘Professional: Extensive industry experience (10+ years)’, ‘Expert: Completed 50 successful jobs on the platform’ and ‘Master: Completed 100 successful jobs on the platform’.

To access a higher band, certain criteria must be met, such as a specified number of verified qualifications and or accreditations, a specified period in the trade, a specified number of relationships with other users or a specified maximum quantity of alerts. In this way, the user is provided with motivation to improve their user score by improving their industry experience, skills, knowledge, competency and reputability in the trade. Additionally, other incentives may be provided to encourage the user to improve their user score and access higher bands, such as greater flexibility in which verifiable data can be provided, greater access to other services provided on the platform and an increased number of user relationship options to choose from.

Each user score is continually or periodically reviewed and updated on the central resource. In this way, if a user has been inactive for a number of years, their score falls until proof of recent work, maintenance of training and conformity to new laws has been proven. Additionally, if the user score of an associated user changes, such as another user with a predetermined relationship to the user, this is reflected in the score of the user; a reduction in the user score of a trainee can negatively impact the user score of a trainer.

Additionally, if the verifiable data or reference source is provided by a prior user, such as another user in the same trade, the data associated with the prior user on the central resource is considered. For example, if a referee of the REFERENCING stage 208 is a prior user and has a low rank or user score, this data is linked to the user on the central resource and an alert is issued.

In this way, there is provided a method 200 to verify and confirm a user's credentials, wherein a quantified user score and ranking system improves transparency of information regarding users and motivates users to improve their industry experience, skills, knowledge, competency and reputability.

1. A computer implemented method for confirming the credentials of a user comprising the method steps of:
allowing said user to create a profile containing verifiable data;
recording the verifiable data to a central resource;
cross checking an item of verifiable data with a reference source;
recording data associated with the result of the cross check to the central resource; and
recording data associated with at least one method step to the central resource.

2. The computer implemented method of claim 1, wherein the method comprises cross checking an item of verifiable data against a plurality of reference sources.

3. The computer implemented method of claim 1 or claim 2, wherein the method comprises cross checking a plurality of items of verifiable data against a plurality of reference sources.

4. The computer implemented method of any one preceding claim, wherein the method comprises the further review step of:
comparing data associated with two or more method steps recorded to the central resource; and
issuing an alert if the comparison produces a result outside of a desired range.

5. The computer implemented method of claim 4, wherein the review step comprises determining the desired range from data stored on the central resource.

6. The computer implemented method of claim 5, wherein the data stored on the central resource comprises prior user data associated with a prior user.

7. The computer implemented method of any one of claims 4 to 6, wherein the review step further comprises recording data associated with the presence or absence of an alert to the central resource.

8. The computer implemented method of any one of claims 4 to 7, wherein the data comprises the time the method steps were completed,
comparing the data associated with the completion of two or more method steps recorded to the central resource comprises determining the elapsed time period between the completion of the two or more method steps; and
issuing an alert if the comparison produces a result outside of a desired range comprises issuing a time alert if the elapsed time period is outside of a desired range.

9. The computer implemented method of any one of claims 4 to 7, wherein the data comprises location information,
comparing the data associated with the completion of two or more method steps recorded to the central resource comprises determining the proximity between the locations where completion of the two or more method steps occurred; and
issuing an alert if the comparison produces a result outside of a desired range comprises issuing a proximity alert if the proximity is outside of a desired distance range.

10. The computer implemented method of any one preceding claim, wherein the method comprises the further steps of:
reviewing the data associated with at least one method step recorded to the central resource, wherein the data comprises location information;
comparing the location information to an item of verifiable information contained within the profile; and
issuing a location alert if there is a discrepancy between the location information and the item of verifiable information.

11. The computer implemented method of any one preceding claim, wherein the or the plurality of reference sources comprises a third-party database.

12. The computer implemented method of any one preceding claim, wherein the or the plurality of reference sources comprises the central resource.

13. The computer implemented method of any one preceding claim, wherein the or the plurality of reference sources comprises information provided by a customer or quality controller.

14. The computer implemented method of any one preceding claim, wherein the or the plurality of reference sources comprises information provided by a second user.

15. The computer implemented method of claim 14, wherein the method further comprises recording the association between the user and the second user in the central resource.

16. The computer implemented method of claim 15, wherein the method further comprises the step of defining a predetermined relationship status to the association between the user and the second user and recording this relationship in the central resource.

17. The computer implemented method of any one preceding claim, wherein the method simultaneously confirms the credentials of multiple users.

18. The computer implemented method of claim 17, wherein the method comprises the further steps of analysing the data recorded in the central resource, and providing each user with a user score.

19. The computer implemented invention method of claim 18, wherein the method comprises the further step of recording each user's user score in the central resource.

20. The computer implemented method of claim 18 or claim 19, comprising the further step of continually or periodically reviewing the data recorded in the central resource, and updating each user's user score.

21. The computer implemented method of claim 18, claim 19 or claim 20, comprising the further step of ranking each user by their user score.

22. A data processing apparatus comprising means for carrying out the method of any one preceding claim.

23. A computer program comprising instructions which, when the program is executed by a computer, cause the computer to carry out the method of any one of claims 1 to 21.

24. A computer-readable medium comprising instructions which, when executed by a computer, cause the computer to carry out the method of any one of claims 1 to 21.
